(19) United States
(12) Patent Application Publication
(10) Pub. No.: US 2004/0236642 A1
(43) Pub. Date: Nov. 25, 2004

(54) WebCollect Method

(76) Inventor: David Bruckman, Armonk, NY (US)

Correspondence Address: AdviceHere.Com, Inc., PO Box 504, Armonk, NY, 10504, US

(21) Appl. No.: 10/440,551

(22) Filed: May 19, 2003

(51) Int. Cl. G06F 17/60

(52) U.S. Cl. 705/28

(57) ABSTRACT

I seek a business method patent for a new and novel judgment enforcement technique, known presently as the Netcollect Method, that utilizes the internet technology to assist bona fide judgment creditors with unsatisfied judgments get paid. The Netcollect Method technique has as its foundation a central database of judgments, submitted to the website www.judgmentweb.com by the judgment creditors for a fee, which can be searched by the public at no charge via the website. Heretofore, inquirers had no easy and free means to ascertain the existence of such judgments. The fact that inquires can now easily and at no cost ascertain the existence of such judgments provides an incentive for judgment debtors to settle (pay the creditor). If the debtor settles, the judgment is not posted on the websites judgment database, and the creditor must issue a satisfaction of judgment form before receiving any money. If, after a designated time period, the debtor does not settle, the judgment is posted on the judgment database of the website. In summary, the technique for which protection is sought encompasses the specific individual steps from start to finish.

### BACKGROUND

The name, “Netcollect Method” is not as important as the actual technique. Presently, a trade or service mark application is pending on the name, “Netcollect Method”. In the event it is not granted, the technique will be given a different name. It is the technique, as described below, for which the protection of a so-called “business-method” or utility patent is sought.

The inventor, David B. Bruckman, is a licensed attorney with extensive experience in collections and the workings of small claims courts. David B. Bruckman is the president of a corporation called AdviceHere.com, Inc., which owns and operates and internet company called JudgmentWeb.com (“JudgmentWeb”). The domain name of JudgmentWeb.com is www.judgmentweb.com. The website has been fully operational since on or about Apr. 15, 2003. The Netcollect Method is a program, or technique, that utilizes the internet, through JudgmentWeb, to assist bona fide judgment creditors with the enforcement of their judgments. It should be noted that JudmentWeb does not dispense or offer legal advice or services, and that the NetCollect Method is not a legal process or a legal service.

The invention has been in development for about two years. The inventor became interested in a finding a better way to compel debtors, especially those that are judgment proof judgment proof is a name associated with a debtor that has no assets (or at least no assets that can be found) and/or no income to attach or garnish) to pay the money rightfully owed to the judgment creditor. Many of the inventor's clients would spend significant time and money on legal fees only to obtain a judgment, but never collect any money. The judicial process and court personnel cannot and will not help a judgment creditor get paid. Judgment enforcement is left to the individual whether the judgment is for $200.00 from a small claims court or for $1,000,000 from a federal district court. The inventor himself experience the frustration shared by many of his clients when he obtained a judgment and never received any payment. Consequently, Mr. Bruckman invented the NetCollect Method technique to help judgment creditors get paid.

### BRIEF SUMMARY

The Netcollect Method technique involves the docketing (or posting/listing) of bona fide unsatisfied judgments on a database at the JudgmentWEb website. The judgments are provided to JudgmentWeb by judgment creditors. After being contacted by JudgmentWEb, if the judgment debtor refuses to “settle”, the judgment (which is a public record) is listed on the JudgmentWeb.com website. Any person can search JudgmentWeb's judgment database at no charge. The judgment remains on the JudgmentWeb database until such time as the debtor goes bankrupt and the judgment is discharged, the debtor supplies JudgmentWeb with a satisfaction of judgment, the case “settles” via JudgmentWEb or the creditor directs JudgmentWeb to delete the judgment from the database. Debtors, ostensibly, will not want their names and information about their judgment on the database, where anybody can see it including prospective employers, lenders, customers, landlords, human resource personnel, accounts receivable personnel, the government, insurance carriers and credit rating agencies. Without the Netcollect Method, there is no centralized depository of judgments and no means where the existence of judgments can be research for free (short of visiting the thousands of courthouses where the judgments are recorded), and via the internet. Consequently, because of the NetCollect Method technique, such a debtor has an incentive to settle, that did not heretofore exist.

### VIEW OF DRAWINGS

There is no drawing for the invention. The invention is a technique that is incapable of illustration.

### DETAILED PROGRAM SUMMARY

The Netcollect Method is a technique that involves a series of steps, or transactions, through JudgmentWeb.

Step 1—Judgment Creditor accesses the JudgmentWeb website.

Step 2—Judgment Creditor downloads the Retainer Agreement from the website.

Step 3—Judgment Creditor completes and signs the Retainer Agreement.

Step 4—Judgment Creditor returns the Retainer Agreement with a (court) certified copy of the original judgment to AdviceHere.com, Inc.

Step 5—JudgmentWeb sends its customized “Demand” letter to the debtor explaining the terms of proposed settlement. The proposed settlement always involves the judgment creditor accepting an amount less than the face amount (or current balance due) of the judgment. There is no negotiation through JudgmentWeb. The amount and terms of the proposed settlement as set forth in the Demand letter are absolute. The Debtor is informed that failure to settle will result of the docketing (posting) of the name of the debtor and information concerning the judgment in the judgment database of the website of JudgmentWeb.

Step 6—In the event the debtor settles (pays) in a timely manner, within 35 days of the date of the Demand Letter, the Judgment Creditor must timely execute a Satisfaction of Judgment before any sum is released from escrow by AdviceHere.com, Inc. to the Creditor.

Step 7—In the event the debtor fails to timely settle, the judgment and name of debtor are docketed (posted) in the judgment database of JudgmentWeb. Specifically, the following information is posted in the judgment database: name of debtor, debtor's last known address and the dollar amount of the judgment. The judgment database may be searched by the public and no charge via the website of JudgmentWeb.

This step encompasses the novelty of the technique and is the basis for patent protection. The inventor is unaware of any such or similar method of posting judgments on a searchable database at no charge as a means of inducing settlement of unsatisfied judgments.

Step 8—The judgment remains in the judgment database until settlement occurs, the debtor provides AdviceHere.com, Inc. with a satisfaction of the judgment or a discharge of the judgment in bankruptcy, or the judgment creditor authorizes the removal of the judgment.

1. What I claim as my invention is the technique presently known as the Netcollect Method and described in this specification.
